(19) United States
(12) Patent Application Publication
(10) Pub. No.: US 2013/0017517 A1
(43) Pub. Date: Jan. 17, 2013

(54) METHOD AND APPARATUS FOR LEAVING MESSAGES FOR PASSED LOVED ONES

(71) Applicant: CARL ROY SCIANNA, Lisle, IL (US)

(72) Inventor: CARL ROY SCIANNA, Lisle, IL (US)

(21) Appl. No.: 13/184,416

(22) Filed: Jul. 15, 2011

(51) Int. Cl. G09B 19/00; H04M 3/42

(52) U.S. Cl. 434/236; 379/201.01

(57) ABSTRACT

An apparatus and method for people to leave a message to a passed loved one includes a web site established to provide potential users with a description of the service available. The website may explain the website's owner, a therapist's credentials, and may explain the concept of providing closure with the methods and apparatus of the present invention. The website may provide information regarding a cost to the user. The website will direct the user to call a certain phone number to leave a message for their passed loved one.

### BACKGROUND OF THE INVENTION

The present invention relates to apparatus and methods for leaving messages for passed loved ones and, more particularly, to a phone number made available for a survivor to leave a message for a passed loved one.

When a loved one passes, the ones left behind may feel like the loved one passed too quickly. The ones left behind may have more to say to their loved one and may not feel closure until they are able to do so.

As can be seen, there is a need for a method and apparatus for leaving messages for passed loved ones.

### SUMMARY OF THE INVENTION

In one aspect of the present invention, a system for leaving a message for a passed loved one comprises a web site adapted to provide information on the system, on payment methods, and on how to proceed with leaving a message; and a telephone system adapted to allow a user to call in, make payment, and leave the message for the passed loved one.

In another aspect of the present invention, a computer system having computer code stored on computer readable medium, the computer code comprises computer code providing a web site adapted to provide information on the system, on payment methods, and on how to proceed with leaving a message; and computer code providing a telephone system adapted to allow a user to call into the telephone system, make payment, and leave the message for a passed loved one.

In a further aspect of the present invention, a method for psychologically treating a patient who has lost a loved one comprises directing the patient to a web site adapted to provide information on a passed loved one messaging system, on payment methods for using the system, and on how to proceed with leaving a message; and directing the patent to call a telephone system adapted to allow the patient to call into the telephone system, make payment, and leave the message for the passed loved one.

These and other features, aspects and advantages of the present invention will become better understood with reference to the following description and claims.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides an apparatus and method for people to leave a message to a passed loved one. A web site may be established to provide potential users with a description of the service available. The website may explain the website's owner, a therapist's credentials, and may explain the concept of providing closure with the methods and apparatus of the present invention. The website may provide information regarding a cost to the user. The website will direct the user to call a certain phone number to leave a message for their passed loved one.

In some embodiments, the website may provide an option for permitting certain messages to be digitized and sent out into the universe, for example, into space via satellite beyond the Earth's atmosphere. This may provide a further level of closure to the survivor.

In some embodiments, the user may make their payment online, at the website and be provided with an access number. In other embodiments, payment may be made at the time of making the call with, for example, a credit or debit card.

The present invention may include computer code stored on computer readable medium to perform a number of steps. For example, the computer code may be configured to provide the website, the instructions on the website, and the like. Further computer code may be provided to control a telephone system, where users may call in and leave a message for their passed loved one. Additional computer code may be provided to optionally direct the user's message into the universe via a satellite transmission, for example. Finally, computer code may be provided to calculate and collect payment from the user. The payment may be made as part of the phone system or part of the internet system.

The present invention further provides a method for psychologically treating a patient by allowing the patient to record a message for a passed loved one on a telephone answering system. The method may optionally provide further closure to the patient by permitting the message to be transmitted into the universe by, for example, a digitized satellite transmission.

To use the system of the present invention, a user may sign into a web site, read the pertinent information thereupon, call an access number, provide payment information, and record their message.

The system of the present invention may be provided as an adjunct to psychological care by a licensed psychologist. In some embodiments, the system of the present invention may be available for use by the general public.

While the above describes a method and system for sending messages to passed loved ones, messages may be similarly sent to persons that are alive, for example, sick or terminally ill people. While the above refers to loved ones, such a qualifier should not reflect any particular relationship between the user and the intended recipient. For example, a user may send a message to a person which, for example, has passed, that they were not particular fond of. Such use would be contemplated within the scope of the present invention.

It should be understood, of course, that the foregoing relates to exemplary embodiments of the invention and that modifications may be made without departing from the spirit and scope of the invention as set forth in the following claims.

What is claimed is:

1. A system for leaving a message for a passed loved one, comprising:
a web site adapted to provide information on the system, on payment methods, and on how to proceed with leaving a message; and
a telephone system adapted to allow a user to call in, make payment, and leave the message for the passed loved one.

2. The system of claim 1, further comprising a transmitting system adapted to transmit the message into space.

3. The system of claim 2, wherein the transmitting system includes transmitting the message via a satellite.

4. The system of claim 3, wherein the message is digitized.

5. A computer system having computer code stored on computer readable medium, the computer code comprising:
computer code providing a web site adapted to provide information on the system, on payment methods, and on how to proceed with leaving a message; and
computer code providing a telephone system adapted to allow a user to call into the telephone system, make payment, and leave the message for a passed loved one.

6. The computer system of claim 5, further comprising computer code for transmitting the message into space.

7. A method for psychologically treating a patient who has lost a loved one, the method comprising:
directing the patient to a web site adapted to provide information on a passed loved one messaging system, on payment methods for using the system, and on how to proceed with leaving a message; and
directing the patient to call a telephone system adapted to allow the patient to call into the telephone system, make payment, and leave the message for the passed loved one.

8. The method of claim 7, further comprising receiving counseling from a psychologist during the patient's treatment.

9. The method of claim 7, further comprising providing an option to transmit the message into space via a satellite transmission.

10. The method of claim 7, further comprising providing an option for the patient to review and record the message prior to sending.
